(19) United States
(12) Patent Application Publication
(10) Pub. No.: US 2020/0149974 A1
(43) Pub. Date: May 14, 2020

(54) Contact Temperature Sensor

(71) Applicant: TDK Electronics AG, Munich (DE)

(72) Inventors: Thomas Hand, Berlin (DE); Michael Schmidt, Gross-Beeren (DE)

(73) Assignee: TDK Electronics AG, Munich (DE)

(21) Appl. No.: 16/631,078

(22) PCT Filed: Jul. 5, 2018
(86) PCT No.: PCT/EP2018/068278

§ 371 Date: Jan. 14, 2020

(30) Foreign Application Priority Data
Jul. 21, 2017 (DE) 10 2017 116 533.9

(51) Int. Cl. G01K 1/14; G01K 1/18; G01K 7/02

(52) U.S. Cl. CPC G01K 1/143; G01K 7/02; G01K 1/18

(57) ABSTRACT

A contact temperature sensor is disclosed. In an embodiment a contact temperature sensor includes a contact body including a bottom wall configured to apply the contact temperature sensor on a test body and a carrier ceramics configured to thermally directly couple the contact temperature sensor to the test body, wherein the carrier ceramics is arranged on a side of the bottom wall facing the test body, and wherein the carrier ceramics includes a metallization on a side facing the test body. The contact temperature sensor further includes a temperature sensor element thermally coupled to the carrier ceramics.

This patent application is a national phase filing under section 371 of PCT/EP2018/068278, filed Jul. 5, 2018, which claims the priority of German patent application 102017116533.9, filed Jul. 21, 2017, each of which is incorporated herein by reference in its entirety.

### TECHNICAL FIELD

The invention relates to a contact temperature sensor with a temperature sensor element for detecting a temperature.

### BACKGROUND

Electric temperature sensors, in which the transfer of heat between a test object and a sensor occurs only via a certain contact surface, are called contact temperature sensors. Contact temperature sensors are often used for the indirect temperature measurement of fluids in pipes. In the case that the contact temperature sensors are applied to pipes of poor heat conduction, the response time of the sensor elements of the contact temperature sensors increases, and predetermined response time requirements for certain applications, e.g., in the automotive sector, cannot be met.

### SUMMARY OF THE INVENTION

Embodiments provide a contact temperature sensor which allows for a sufficiently good heat transfer from a test body to a sensor element of the contact temperature sensor.

Embodiments provide a contact temperature sensor with a contact body. The contact body comprises a bottom wall for applying the contact temperature sensor on a test body. The contact temperature sensor includes a carrier ceramics for the direct thermal coupling of the contact temperature sensor with the test body. The carrier ceramics is arranged on a side of the bottom wall facing the test body. Furthermore, the contact temperature sensor comprises a temperature sensor element, which is thermally coupled to the carrier ceramics.

The carrier ceramics is arranged in such a way that it is directly thermally or mechanically coupled with the test body in a mounted state of the contact body on the test body. As used herein, directly thermally-coupled means without interposition of further components and that the carrier ceramics and the test body contact one another.

The direct arrangement of the carrier ceramics on the test body in the mounted state advantageously makes a reduction of heat transfer locations possible. Faster response of the contact temperature sensor can be realized by the improved heat transfer from the surface of the test body to the temperature sensor element.

In an advantageous configuration, the carrier ceramics comprises a metallization on a side facing the test body and/or on a side facing away from the test body. The metallization allows a good and fast heat conduction and thus a less lossy transfer of thermal energy from the test body to the carrier ceramics and the temperature sensor element. The metallization, which is arranged on the side of the carrier ceramics facing the test body, and/or the metallization which is arranged on the side of the carrier ceramics facing away from the test body can, in particular, include copper or silver.

In a further advantageous configuration, the side of the carrier ceramics facing the test body comprises a metallization over the entire surface. Advantageously, the heat transfer can be further improved in this way.

Furthermore, the carrier ceramics comprises a structured metallization on the side facing away from the test body. This makes a suitable electric contacting of the temperature sensor element possible in a simple manner.

In a further advantageous configuration, the carrier ceramics comprises silicon nitride, or consists of silicon nitride. Compared with other ceramic materials, silicon nitride has a higher breaking strength. Due to the direct mounting of the carrier ceramics on the test body, the carrier ceramics can be subject to higher mechanic or thermal stress. The use of silicon nitride as a ceramics carrier material thus comes with the advantage that a reliability of the contact temperature sensor can be increased. Alternatively or additionally, other ceramic materials can be used as well, in particular aluminium oxide, for example.

In a further advantageous configuration, the temperature sensor element comprises an NTC thermistor. The NTC thermistor can also be referred to as an NTC (Negative Temperature Coefficient) resistor. The NTC thermistor has a resistance with a negative temperature coefficient. Advantageously, the NTC thermistor makes it possible that a temperature, or a temperature change, on the surface of the test body can be detected in a very simple and cost-efficient manner.

In a further advantageous configuration, the temperature sensor element is coupled with the carrier ceramics via a positive substance-to-substance bond. The positive substance-to-substance bond can include a soldered connection. Alternatively, the positive substance-to-substance bond can be manufactured by means of a common sintering of the carrier ceramics with the temperature sensor element.

In a further advantageous configuration, the contact temperature sensor comprises at least one contact for the electric coupling with an evaluation means, and the temperature sensor element and/or the carrier ceramics are respectively coupled and/or directly connected to the at least one electric contact via an electrically-conducting connection wire. The connection wire may comprise a plating. The contact comprises a contact pin, for example.

In a further advantageous configuration, the respective electrically-conducting connection wire includes a conductor that comprises an iron nickel alloy. A copper plating is applied on to the conductor. In particular, the connection wire can be configured as a Dumet wire. Advantageously, such a connection wire has a lower heat conductivity compared with standard wires made of copper or aluminium. As a result, a heat dissipation from the temperature sensor element, in particular from the NTC thermistor chip, can be reduced.

In a further advantageous configuration, the metallization on the side of the carrier ceramics facing away from the test body and/or the temperature sensor element is connected to the respective electrically-conducting connection wire via an electrically-conductive connection. The connection can be produced by means of welding, soldering, bonding or gluing.

In a further advantageous configuration, the carrier ceramics can the temperature sensor element have a common potting. The potting is preferably configured in such a way that the NTC thermistor is resistant to moisture and/or other environmental impacts, and thus the temperature sensor element has a higher reliability. The potting in particular prevents moisture from penetrating the NTC thermistor.

### BRIEF DESCRIPTION OF THE DRAWINGS

In the following, exemplary embodiments of the invention are explained with reference to the schematic drawings.

FIG. 1 shows a sectional view of an exemplary embodiment of a contact temperature sensor;

FIG. 2 shows a first sectional view of an exemplary embodiment of a contact body of the contact temperature sensor; and

FIG. 3 shows a second sectional view of the exemplary embodiment of the contact body.

Elements of identical construction or function are denoted by the same reference characters throughout the Figures.

### DETAILED DESCRIPTION OF ILLUSTRATIVE EMBODIMENTS

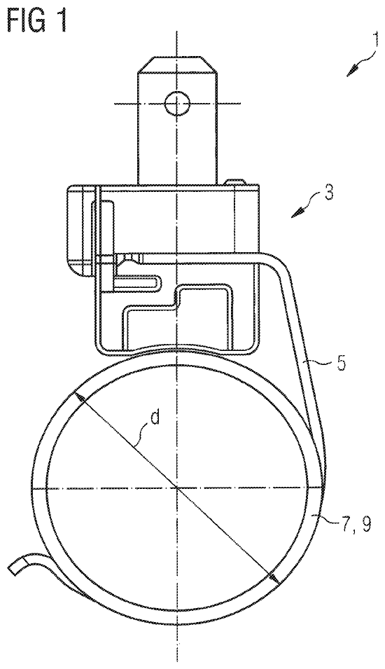

FIG. 1 shows a sectional view of an exemplary embodiment of a contact temperature sensor 1. The contact temperature sensor 1 comprises a contact body 3 and, for example, a tension clamp 5. One end of the tension clamp 5 is mechanically coupled with the contact body 3, for example. The tension clamp 5 is arranged and configured to press the contact body 3 on to a test body 7, and to fix the contact body 3 to the test body 7. Alternatively, the contact temperature sensor 1 can comprise a fastener strap which is attached to the contact body 3 with both ends, respectively. A length of the fastener strap advantageously is adjustable.

In the exemplary embodiment shown, the contact temperature sensor 1 is mounted on a test body 7 in the form of a pipe 9. Inside the pipe, 9, a fluid (not shown here), e.g., a coolant, can be present in a manner to be flowing or at rest. The fluid can comprise a gas and/or a liquid. The contact temperature sensor 1 includes a temperature sensor element 30, which is in thermal contact with the pipe 9. The contact body 3 comprises a plug housing 13. A contact pin 15 for the electric coupling with an evaluation means is arranged inside the plug housing 13, which pin is connected with the temperature sensor element 30 via conducting connections.

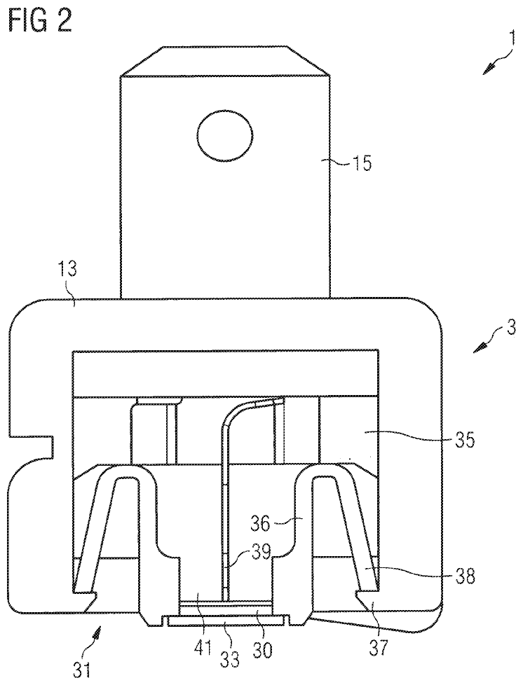

FIG. 2 shows a first sectional view of an exemplary embodiment of the contact body 3 in detail. The contact body 3 comprises a bottom wall 31 for applying the contact temperature sensor 1 on the test body 7.

The contact body 3 includes a carrier ceramics 33 for the direct thermal coupling of the test body 7 with the contact temperature sensor 1. The carrier ceramics 33 is arranged on a side of the bottom wall 31 facing the test body 7.

The contact body 3 comprises a hollow space 35 with an opening, for example. The opening is arranged in the bottom wall 31 of the contact body 3 and is at least in part covered or closed by the carrier ceramics 33.

For example, a holding element 36 is at least in part arranged in the hollow space 35. The holding element 36 is arranged and configured to hold the temperature sensor element 30 and the carrier ceramics 33.

The holding element 36 is forming as a holding bracket, for example. The holding element 36 is held in the hollow space 35 of the contact body 3 by means of a clamping connection, for example. An inner wall of the hollow space 35 comprises latch hooks 37, for example, on which bracket limbs 38 of the holding brackets are supported.

The carrier ceramics 33 is coupled with the holding element 36 in a mechanic manner, for example.

The carrier ceramics 33 preferably comprises silicon nitride, or consists of silicon nitride. Silicon nitride has a high breaking strength. It is alternatively possible that the carrier ceramics 33 includes an alternative or further ceramics material, for example alumina. In other words, the ceramics material can be selected dependent upon the requirements in terms of breaking strength, thermal conductivity and/or processability.

For the efficient take-up of the thermal energy of the test body 7, the carrier ceramics 33 preferably comprises a metallization over the entire surface, on the side facing the test body 7.

On a side of the carrier ceramics facing away from the test body 7, a temperature sensor element 30 is arranged, which is thermally coupled with the carrier ceramics 33.

The temperature sensor element 30 is preferably thermally and mechanically directly coupled with the carrier ceramics 33. The carrier ceramics 33 comprises a metallization of the side facing away from the test body 7, preferably a structured metallization. The metallization can include silver or copper, or consists of silver or copper.

The temperature sensor element 30 is coupled with the carrier ceramics 33 via a positive substance-to-substance bond. The positive substance-to-substance bond can include a soldered connection. Alternatively, the positive substance-to-substance bond can be produced by means of a common sintering of the carrier ceramics 33 with the temperature sensor element 30. The temperature sensor element 30 preferably also comprises a ceramic material in this case. Sintering can occur in non-pressurized or pressurized manner.

The temperature sensor element 30 preferably includes an NTC thermistor, also called NTC (Negative Temperature Coefficient) resistor.

The contact temperature sensor 1 includes at least one contact for the electric coupling with an evaluation means. The temperature sensor element 30 and/or the carrier ceramics 33 are respectively coupled and/or directly connected to the at least one electric contact via an electrically-conducting connection wire 39.

The connection wire 39 preferably comprises a plating. The respective electrically-conducting connection wire 39 comprises a conductor that includes an iron nickel alloy, for example. A copper plating is applied on to the conductor, for example.

The metallization on the side of the carrier ceramics 33 facing away from the test body, and/or the temperature sensor element 30 is preferably connected to the respective electrically-conducting connection wire 39 via a positive substance-to-substance bond.

The carrier ceramics 33 and the temperature sensor element 30 preferably comprise a common potting 41. The potting 41 is applied on to the carrier ceramics 33 essentially on the side facing away from the test body 7 in such a way that the temperature sensor element 30 and the carrier ceramics 33 are covered with the potting 31 on the side facing away from the test body 7 where they are not covered by a plastic material of the holding element 36 and/or of the contact body 3.

The potting 41 is preferably configured and arranged in such a way that no moisture can enter into the temperature sensor element 30, and the carrier ceramics 33 is supported substantially over the entire surface, or over the entire surface, on the side of the carrier ceramics 33 facing away from the test body. In this way, a bending or breaking of the carrier ceramics 33 and/or of the temperature sensor element 30 can be largely prevented, and a reliability of the contact temperature sensor 1 is increased.

The direct thermal or mechanical coupling of the carrier ceramics 33 with the test body 7 provides the advantage that a response time can be substantially shortened. Heat transfer locations can be reduced, and required or desired response periods of the contact temperature sensor 1 can be realized dependent upon respective dimensions, in particular in terms of a thickness of the carrier ceramics 33.

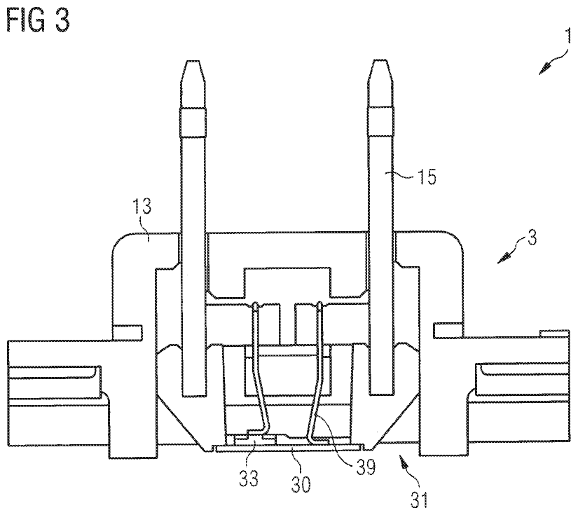

FIG. 3 shows a second sectional view of the exemplary embodiment of the contact body 3.

The invention is not limited to the exemplary embodiments due the description by means of the exemplary embodiments. The invention rather comprises any new feature as well as any combination of features, which in particular includes any combination of features in the claims, even though this feature or this combination of features is per se not explicitly indicated in the claims or in the exemplary embodiments.

1-11. (canceled)

12. A contact temperature sensor comprising:
a contact body comprising:
a bottom wall configured to apply the contact temperature sensor on a test body; and
a carrier ceramics configured to thermally directly couple the contact temperature sensor to the test body,
wherein the carrier ceramics is arranged on a side of the bottom wall facing the test body, and
wherein the carrier ceramics comprises a metallization on a side facing the test body; and
a temperature sensor element thermally coupled to the carrier ceramics.

13. The contact temperature sensor according to claim 12, wherein the carrier ceramics comprises a metallization on a side facing away from the test body.

14. The contact temperature sensor according to claim 13, wherein the carrier ceramics comprises a structured metallization on the side facing away from the test body.

15. The contact temperature sensor according to claim 12, wherein the carrier ceramics comprises a metallization over the entire surface on the side facing the test body.

16. The contact temperature sensor according to claim 15, wherein the carrier ceramics comprises a structured metallization on a side facing away from the test body.

17. The contact temperature sensor according to claim 12, wherein the carrier ceramics comprises silicon nitride.

18. The contact temperature sensor according to claim 12, wherein the carrier ceramics consists essentially of silicon nitride.

19. The contact temperature sensor according to claim 12, wherein the temperature sensor element includes an NTC thermistor.

20. The contact temperature sensor according to claim 12, wherein the temperature sensor element is coupled to the carrier ceramics via a positive substance-to-substance bond.

21. The contact temperature sensor according to claim 12, wherein the contact temperature sensor comprises at least one contact for electrical coupling with an evaluation means, and wherein the temperature sensor element and/or the carrier ceramics comprises an electrically-conductive connection wire coupled to the at least one contact, the electrically-conductive connection wire comprising a plating.

22. The contact temperature sensor according to claim 21, wherein the electrically-conducting connection wire comprises a conductor comprising an iron-nickel-alloy, and a copper plating located on the conductor.

23. The contact temperature sensor according to claim 12, wherein the metallization on the side of the carrier ceramics facing away from the test body, and/or the temperature sensor element is connected to an electrically-conductive connection wire via a positive substance-to-substance bond.

24. The contact temperature sensor according to claim 12, wherein the carrier ceramics and the temperature sensor element comprise a common potting.

25. A contact temperature sensor comprising:
a contact body comprising:
a bottom wall configured to apply the contact temperature sensor on a test body; and
a carrier ceramics configured to thermally directly couple the contact temperature sensor to the test body,
wherein the contact temperature sensor is arranged on a side of the bottom wall facing the test body, and
wherein the carrier ceramics comprises a metallization on a side facing the test body; and
a temperature sensor element thermally coupled to the carrier ceramics.

26. The contact temperature sensor according to claim 25, wherein the carrier ceramics comprises a metallization over the entire surface on the side facing the test body.

27. The contact temperature sensor according to claim 26, wherein the carrier ceramics comprises a structured metallization on a side facing away from the test body.

28. The contact temperature sensor according to claim 27, wherein the metallization on the side of the carrier ceramics facing away from the test body, and/or the temperature sensor element is connected to an electrically-conductive connection wire via a positive substance-to-substance bond.

29. The contact temperature sensor according to claim 26, wherein the temperature sensor element is coupled to the carrier ceramics via a positive substance-to-substance bond.

30. The contact temperature sensor according to claim 26, wherein the contact temperature sensor comprises at least one contact for electrical coupling with an evaluation means, and wherein the temperature sensor element and/or the carrier ceramics comprises an electrically-conductive connection wire coupled to the at least one contact, the electrically-conductive connection wire comprising a plating.

31. The contact temperature sensor according to claim 30, wherein the electrically-conducting connection wire comprises a conductor comprising an iron-nickel-alloy, and a copper plating located on the conductor.
